(19) United States
(12) Patent Application Publication
(10) Pub. No.: US 2014/0047536 A1
(43) Pub. Date: Feb. 13, 2014

(54) ELECTRONIC DEVICE AND METHOD FOR PERFORMING USER AUTHENTICATION USING ACCESS POINT AND PERIPHERAL DEVICE

(71) Applicant: Samsung Electronics Co., Ltd., Gyeonggi-do (KR)

(72) Inventors: Jae-Hoon JUNG, Gyeonggi-do (KR); Jung-Yoon Kim, Seoul (KR); Michael Pak, Gyeonggi-do (KR)

(73) Assignee: Samsung Electronics Co., Ltd., Gyeonggi-do (KR)

(21) Appl. No.: 13/963,505

(22) Filed: Aug. 9, 2013

(30) Foreign Application Priority Data
Aug. 9, 2012 (KR) 10-2012-0087365

(51) Int. Cl. G06F 21/31; H04L 12/58

(52) U.S. Cl. CPC G06F 21/31; H04L 51/00
USPC 726/16; 709/206

(57) ABSTRACT

An electronic device and method for performing user authentication using at least one of an access point and a peripheral device are provided. The method includes determining whether an electronic device connects to at least one of a stored access point and a stored device within a predetermined time period; and requesting a predetermined user authentication when it is determined that the electronic device has not connected to the at least one of the stored access point and device within the predetermined time period.

### PRIORITY

This application claims priority under 35 U.S.C. §119(a) to Korean Application Serial No. 10-2012-0087365 filed in the Korean Intellectual Property Office on Aug. 9, 2012, the entire content of which is incorporated herein by reference.

### BACKGROUND OF THE INVENTION

1. Field of the Invention

The present invention generally relates to a method for user authentication and an electronic device thereof.

2. Description of the Related Art

An electronic device may store important data, such as a large amount of address book, business data, and a personal finance certificate information. Therefore, a user sets the electronic device to be locked for security by using a password, pattern matching, face recognition, fingerprint scan, or the like.

However, although the user has set the electronic device to be locked by using the above-described methods, if a stranger obtains information about the password or the like by accident, and user authentication has passed only one time, there is a problem in that the stranger can use the electronic device freely. In addition, when the stranger, who has been successfully authenticated, performs a factory reset in the electronic device, there is a problem in that lock settings are permanently deleted.

As a result, there is a need for a technique in which, even though the user does not request user authentication, the electronic device itself requests the user authentication from the user to improve security of the electronic device.

### SUMMARY OF THE INVENTION

The present invention has been made to address at least the problems and disadvantages described above, and to provide at least the advantages described below. Accordingly, aspects of the present invention provide a device and method for requesting an automatically set user authentication to improve security when it is determined that an electronic device does not connect to at least one of a stored access point and a stored peripheral device within a predetermined time period.

Another aspect of the present invention provides a device and method for storing a stored list of access points along with the GPS values corresponding to the access points to eliminate risk caused by hacking.

Another aspect of the present invention provides a device and method for storing a list of stored access points and a list of stored devices in an area to which factory reset can not be applied to improve security.

According to an aspect of the present invention, a method for operating an electronic device for performing user authentication using access point and peripheral device includes determining whether the electronic device connects to at least one of a stored access point and a stored device within a predetermined time period; and requesting a predetermined user authentication when it is determined that the electronic device has not connected to the at least one of the stored access point and device within the predetermined time period.

According to another aspect of the present invention, a method for operating a server for performing user authentication using an access point and a peripheral device includes receiving an emergency message from an electronic device in which user authentication has failed; and receiving the emergency message and transmitting user information to at least one stored email address and telephone number.

According to another aspect of the present invention, an electronic device for performing user authentication using an access point and a peripheral device includes a processor unit for determining whether an electronic device connects to at least one of a stored access point and a stored device within a predetermined time period; and a touchscreen for requesting a predetermined user authentication when it is determined that the electronic device has not connected to the at least one of the stored access point and device within the predetermined time period.

According to another aspect of the present invention, a server for performing user authentication using an access point and a peripheral device includes: a communication module for receiving an emergency message from an electronic device in which user authentication has failed, and transmitting user information to at least one stored email address and telephone number; and a processor unit for controlling overall operation.

### BRIEF DESCRIPTION OF THE DRAWINGS

The above and other aspects, features and advantages of the present invention will become more apparent from the following detailed description when taken in conjunction with the accompanying drawings in which:

FIGS. 1A to 1C are diagrams illustrating an electronic device for performing user authentication using access points and peripheral devices according to an embodiment of the present invention;

FIGS. 2A to 2C are diagrams illustrating requesting user authentication using a stored access point list according to an embodiment of the present invention;

FIGS. 3A to 3C are diagrams illustrating requesting user authentication using a stored device list according to an embodiment of the present invention;

FIGS. 4A to 4D are a diagrams illustrating initializing a stored access point list and a stored device list according to an embodiment of the present invention;

FIG. 5 is a diagram illustrating transmitting an emergency message to at least one email address and telephone number stored in a server when user authentication fails, according to an embodiment of the present invention;

FIG. 6 is a flowchart illustrating operation flow of an electronic device for performing user authentication using access points according to an embodiment of the present invention;

FIG. 7 is a flowchart illustrating operation flow of an electronic device for performing user authentication using devices according to an embodiment of the present invention;

FIG. 8 is a flowchart illustrating operation flow of a server for transmitting an emergency message to a stored email address and telephone number according to an embodiment of the present invention;

FIG. 9 is a block diagram illustrating a configuration of an electronic device according to an embodiment of the present invention; and

FIG. 10 is a block diagram illustrating a configuration of a server according to an embodiment of the present invention.

### DETAILED DESCRIPTION OF EMBODIMENTS OF THE PRESENT INVENTION

Hereinafter, various embodiments of the present invention will be described with reference to the accompanying drawings. In the following description of the present invention, a detailed description of known functions and configurations incorporated herein will be omitted when it may obscure the subject matter of the present invention. Also, the terms used herein are defined according to the functions of the present invention. Thus, the terms may vary depending on users' or operators' intentions or practices. Therefore, the terms used herein must be understood based on the descriptions made herein.

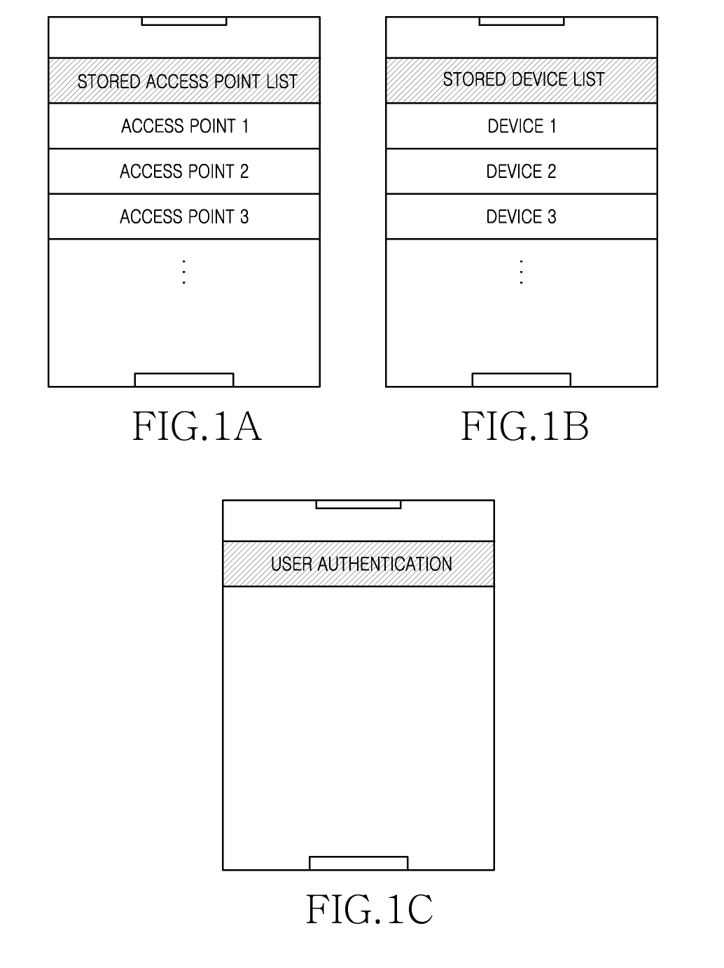

FIGS. 1A to 1C are diagrams illustrating an electronic device for performing user authentication using access points and peripheral devices according to an embodiment of the present invention. FIG. 1A is a diagram illustrating an example of a stored access point list according to the present invention. First, an electronic device automatically stores a list of at least one access point to which the electronic device has connected at least a predetermined number of times within a predetermined time period. Specifically, in order for a user to attempt to make a call, or access Web browsing to search for a variety of information using the electronic device, connection to an arbitrary access point is required. That is, in order to perform communication in a certain area, the electronic device must connect to an access point covering a corresponding area. For example, it is assumed that a user attempts to make a call at home, in an office, and in a partner company respectively using the electronic device. In addition, it is assumed that the home of the user is located in an area covered by an “access point 1,” the office of the user is located in an area covered by an “access point 2,” and the partner company of the user is located in an area covered by an “access point 3.” In this example, when the user attempts to make a call at home using the electronic device, the electronic device connects to the “access point 1.” When the user attempts to make a call in the office, the electronic device connects to the “access point 2.” When the user attempts to make a call in the partner company, the electronic device connects to the “access point 3.”

In the above described example, it is assumed that the predetermined time period is 24 hours, and the predetermined number of times is 4 times. If the electronic device has connected to the “access point 1,” the “access point 2,” and the “access point 3” at least 4 times within 24 hours, the electronic device automatically stores the “access point 1,” the “access point 2,” and the “access point 3” in an access point list. That is, the electronic device automatically stores an access point, to which the electronic device has connected at least a predetermined number of times within a predetermined time period, in the access point list.

Thereafter, the electronic device determines whether it connects to at least one automatically stored access point within the predetermined time period. This process is performed to request user authentication set by the electronic device itself. To avoid problems associated with conventional device locking methods, the electronic device according to the present invention itself requests user authentication from a user at a predetermined time period although the user does not manually request the user authentication, thereby improving the security of the electronic device.

Therefore, the electronic device determines whether it connects at least one stored access point within the predetermined time period, and autonomously requests a predetermined user authentication. That is, when it is determined that the electronic device does not connect to the at least one stored access point within the predetermined time period, the electronic device autonomously requests user authentication and receives the user authentication from a user. In the example above, if the predetermined time period is 48 hours, the electronic device determines whether it connects to any one of the “access point 1,” the “access point 2,” and the “access point 3” within 48 hours, and, if it is determined that there is no connection, the electronic device requests a predetermined user authentication. As a result, the electronic device actively requests user authentication for unlocking of the electronic device, without passively receiving unlock requirements from a user, thereby improving the security of the electronic device.

FIG. 1B is a diagram illustrating an example of a stored device list according to an embodiment of the present invention. First, the electronic device automatically stores a list of at least one device to which the electronic device connects at least a predetermined number of times within a predetermined time period. In this case, the at least one device may include peripheral devices capable of wirelessly communicating with the electronic device. Specifically, the at least one device may include a wireless headset capable of performing Near Field Communication (e.g., Bluetooth or the like) with the electronic device, a personal computer, a vehicle and broadcasting receiver, and the like. For example, a user may listen to music stored in the electronic device by using a wireless headset set to perform Near Field Communication with the electronic device, work on a personal computer (PC) by transmitting a file stored in the electronic device to the PC, and watch moving images on the screen of a broadcasting receiver by transmitting the moving images stored in the electronic device to the broadcasting receiver.

Accordingly, the electronic device automatically stores a list of at least one device to which the electronic device connects at least the predetermined number of times within the predetermined time period. For example, it is assumed that the user has a) listened to music stored in the electronic device by using a wireless headset (device 1), b) worked on a PC by transmitting a file stored in the electronic device to the PC (device 2), and c) listened to music stored in the electronic device by using the audio system of a vehicle (device 3). In addition, it is assumed that the predetermined time period is 72 hours, and the predetermined number of times is 2 times. In this example, if the electronic device has respectively connected to the “device 1,” the “device 2,” and the “device 3” at least 2 times within 72 hours, the electronic device automatically stores the “device 1,” the “device 2,” and the “device 3.” That is, the electronic device may automatically store a device to which it connects at least a predetermined number of times within a predetermined time period in a device list.

Subsequently, the electronic device determines whether it connects to at least one automatically stored device within the predetermined time period. This process is performed to request user authentication set by the electronic device itself. That is, the electronic device according to the present invention autonomously requests user authentication from a user at a predetermined time period even though the user does not manually request the user authentication, thereby improving the security of the electronic device.

Therefore, the electronic device determines whether it connects to at least one stored device within the predetermined time period, and autonomously requests a predetermined user authentication. That is, when it is determined that the electronic device has not connected to the at least one stored device within the predetermined time period, the electronic device autonomously requests user authentication and receives the user authentication from a user. For example, it is assumed that the “device 1,” the “device 2,” and the “device 3” are included in a device list automatically stored in the electronic device, and that a predetermined time period for request of user authentication is 24 hours. In this example, the electronic device determines whether it connects to at least one of the “device 1,” the “device 2,” and the “device 3” within 24 hours, and, if it is determined that there is no connection, requests a predetermined user authentication. As a result, the electronic device actively requests user authentication for unlocking of the electronic device, without passively receiving unlock requirements from a user, thereby improving the security of the electronic device.

FIG. 1C is a diagram illustrating an embodiment of requesting user authentication according to the present invention. In this case, the user authentication may be defined as an arbitrary authentication method for unlocking a locked state set for the security of the electronic device. For example, the authentication method may include a password to be input to the electronic device, pattern matching, face recognition, fingerprint scan, or the like. According to the present invention, when it is determined that the electronic device has not connected to at least one of the stored access point and device within the predetermined time period, the electronic device requests a predetermined user authentication. That is, the user, from which the predetermined user authentication is requested by the electronic device, can continuously use the electronic device only after the user unlocks the electronic device by using the authentication method. For example, if the electronic device is set to be locked using a password, the user must input the password to the electronic device to unlock and, thereafter, use the electronic device continuously. Therefore, according to the present invention, the electronic device undergoes double user authentication, thereby improving the security of the electronic device.

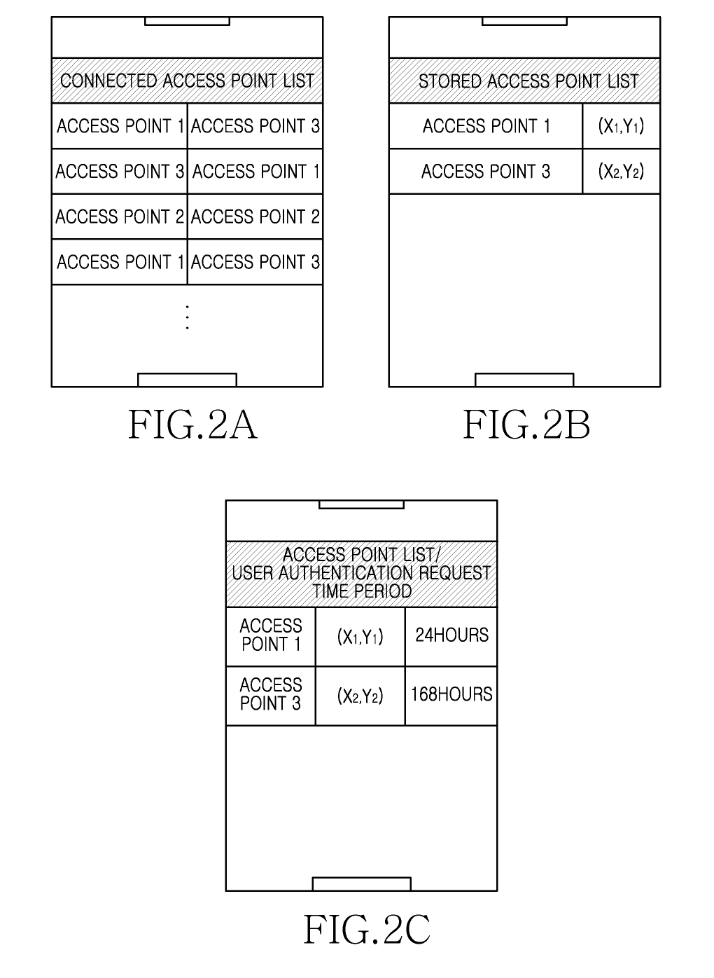

FIGS. 2A to 2C are diagrams illustrating requesting user authentication using a stored access point list according to an embodiment of the present invention. FIG. 2A is a diagram illustrating an example of a list of connected access points. As illustrated in FIG. 2A, an electronic device searches for access points connected to the electronic device in real time in order to automatically store a list of at least one access point connected to the electronic device at least a predetermined number of times within a predetermined time period. For example, when a user transmits and receives a call in an area covered by an “access point 1” using the electronic device, the electronic device searches for access points connected to the electronic device in real time and stores the “access point 1” in a list of connected access points along with a connection date, time and the like. In addition, when the user accesses the Internet in an area covered by an “access point 3” using the electronic device, the electronic device stores the “access point 3” in the list of connected access points along with the connection date, time and the like. In another example, when the user transmits a text message in an area covered by an “access point 2” using the electronic device, the electronic device stores the “access point 2” in the list of access points connected to the electronic device along with the connection date, time and the like. So, in order to automatically store the list of the at least one access point connected to the electronic device at least a predetermined number of times within the predetermined time period, as in the above-described example, the electronic device searches for access points connected to the electronic device in real time, and stores the detected access points in a list of connected access points.

FIG. 2B is a diagram illustrating automatically storing an access point list along with corresponding GPS location values according to an embodiment of the present invention. As illustrated in FIG. 2B, the electronic device may automatically store a list of at least one access point to which the electronic device has connected at least a predetermined number of times within a predetermined time period. For example, it is assumed that the predetermined time period is 48 hours, and the predetermined number of times is 3 times. If it is assumed that the access points illustrated in FIG. 2A have all been connected to the electronic device within 48 hours, the electronic device automatically stores the access point 1 and the access point 3 because they have been connected to the electronic device at least 3 times with the 48 hours. In addition, the electronic device according to the present invention also stores the GPS location value of the corresponding access point when storing the access point list. That is, as illustrated in FIG. 2B, the electronic device also stores corresponding GPS location values for the access points when automatically storing the “access point 1” and the “access point 3” in the access point list.

The purpose of storing the GPS location values along with the access points is to request user authentication by the electronic device if the electronic does not determine that it is located within a predetermined distance from a connected access point although the electronic device connects to at least one stored access point within a predetermined time period. For example, when the electronic device is stolen and hacked by a stranger, the stranger may discover the stored access points, and freely use the electronic device. Accordingly, the electronic device stores the connected access points and their corresponding GPS location values, so that the electronic device can determine whether it is substantially located in the service area of the stored access point. That is, although the electronic device connects to the stored access point within the predetermined time period, whether the electronic device is located within the predetermined distance from the access point to which the electronic device connects is determined using the following Equation (1):

2r≧\sqrt{(x₂−x₁)²+(y₂−y₁)²} (1)

where r denotes the communication radius of a connected access point, (x₁, y₁) denotes the stored GPS coordinates of the connected access point, and (x₂, y₂) denotes the currently measured GPS coordinates of the connected access point.

If Equation (1) is not satisfied, the electronic device is connected to a location that is outside of the communication coverage of the access point and not a stored GPS location corresponding to the stored access point. That is, if Equation (1) is not satisfied, the access point to which the electronic device connects is too far from the stored GPS location, which indicates a possibility that the electronic device connects to a different access point disguised as a stored access point. As a result, the electronic device requests user authentication, thereby addressing a possible risk.

FIG. 2C is a diagram illustrating setting user authentication request time periods for respective access points according to an embodiment of the present invention. As illustrated in FIG. 2C, the electronic device can receive settings for user authentication request time periods for respective access points. In this case, the user authentication request time period may be defined as a time period at which the electronic device determines whether it connects to at least one of the stored access points and requests user authentication. For example, it is assumed that the access point 1 and the access point 3 are included in the access point list automatically stored in the electronic device, and the corresponding user authentication request time periods are 24 hours and 168 hours, respectively.

In this example, the electronic device determines whether it has connected to the “access point 1” in a period of 24 hours and, if it has not, immediately requests user authentication. Similarly, the electronic device determines whether it has connected to the “access point 3” in a period of 168 hours and, if it has not, immediately requests user authentication. That is, there is an advantage in that a user can store different user authentication request time periods for different access points. For example, since at home or in an office where the user spends most of his/her time, the electronic device frequently connects to access points covering the corresponding area(s), it is preferred that the user sets a shorter user authentication request time period. Similarly, since, in an area where the user sometimes visits, the electronic device does not frequently connect to an access point covering the corresponding area, it is preferred that the user set a longer user authentication request time period.

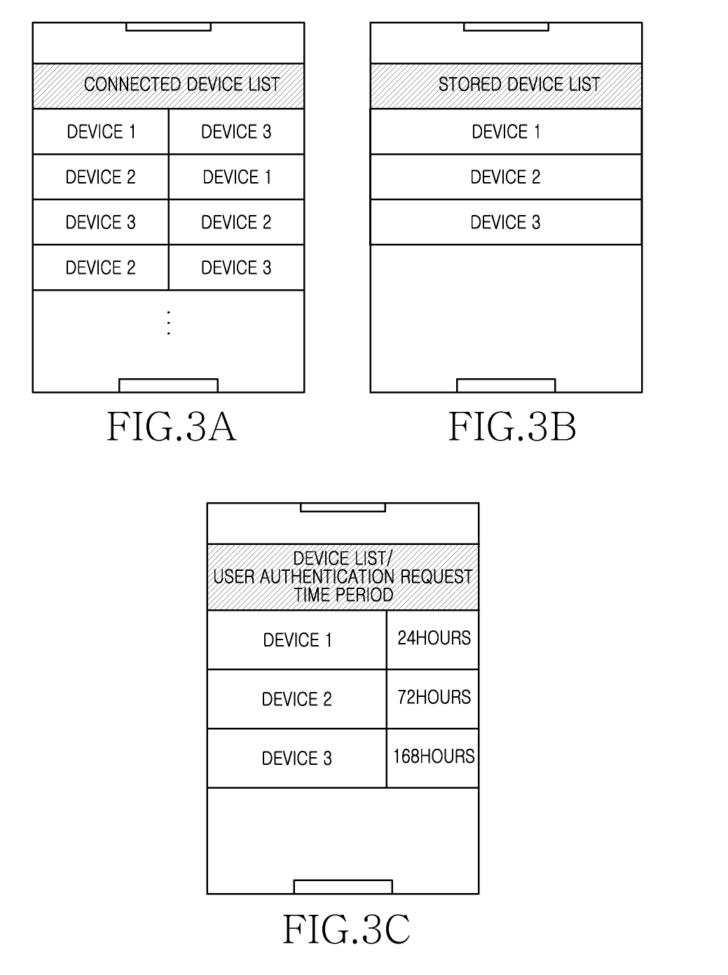

FIGS. 3A to 3C are diagrams illustrating requesting user authentication using a stored device list according to an embodiment of the present invention. FIG. 3A is illustrates an example of a stored device list according to the present invention. As illustrated in FIG. 3A, the electronic device searches for devices the electronic device connects to in real time. Specifically, the electronic device searches for devices to which it connects in real time in order to automatically store a list of at least one device to which it has connected at least a predetermined number of times within a predetermined time period. For example, it is assumed that the user has a) listened to music stored in the electronic device using a wireless headset (device 1), b) worked on a PC by transmitting a file stored in the electronic device to the PC (device 2), and c) listened to music stored in the electronic device by using the audio system of a vehicle (device 3). That is, as in the above-described example, the electronic device searches for devices connected to the electronic device in real time and stores the list of connected devices to compile a list of at least one device the electronic device has connected to at least a predetermined number of times within a predetermined time period.

FIG. 3B is a diagram illustrating automatically storing a device list according to an embodiment of the present invention. As illustrated in FIG. 3B, the electronic device automatically stores a list of at least one device to which the electronic device has connected at least a predetermined number of times within a predetermined time period. For example, it is assumed that the predetermined time period is 72 hours, and the predetermined number of times is 2 times. If it is assumed that the devices illustrated in FIG. 3A have all been connected to the electronic device within 72 hours, the electronic device automatically stores a “device 1,” a “device 2,” and a “device 3” which have been connected to the electronic device at least 2 times within 72 hours.

FIG. 3C is a diagram illustrating setting user authentication time periods for respective devices according to an embodiment of the present invention. As illustrated in FIG. 3C, the electronic device can receive settings for user authentication request time periods of respective devices. In this case, the user authentication request time period may be defined as a time period during which the electronic device determines whether the electronic device connects to at least one of the stored devices, and requests user authentication. For example, it is assumed that a) the device 1, the device 2 and the device 3 are included in the device list automatically stored in the electronic device, and b) their corresponding predetermined time periods are set to 24 hours, 72 hours and 168 hours respectively.

In this example, the electronic device determines whether the electronic device has connected to the “device 1” during the time period of 24 hours, and immediately requests user authentication when the electronic device does not connect to the “device 1” within 24 hours. In addition, the electronic device determines whether the electronic device has connected to the “device 2” during the time period of 72 hours, and immediately requests user authentication when the electronic device does not connect to the “device 2” within 72 hours. Finally, the electronic device determines whether the electronic device has connected to the “device 3” during the time period of 168 hours, and immediately requests user authentication when the electronic device does not connect to the “device 3” within 168 hours. As a result, there is an advantage in that a user can store different user authentication request time periods for different access points. For example, a user may set a shorter user authentication request time period in the case of a PC to which the electronic device connects frequently, and a longer user authentication request time period in the case of a vehicle to which the electronic device does not connect frequently because the user usually uses public transportation.

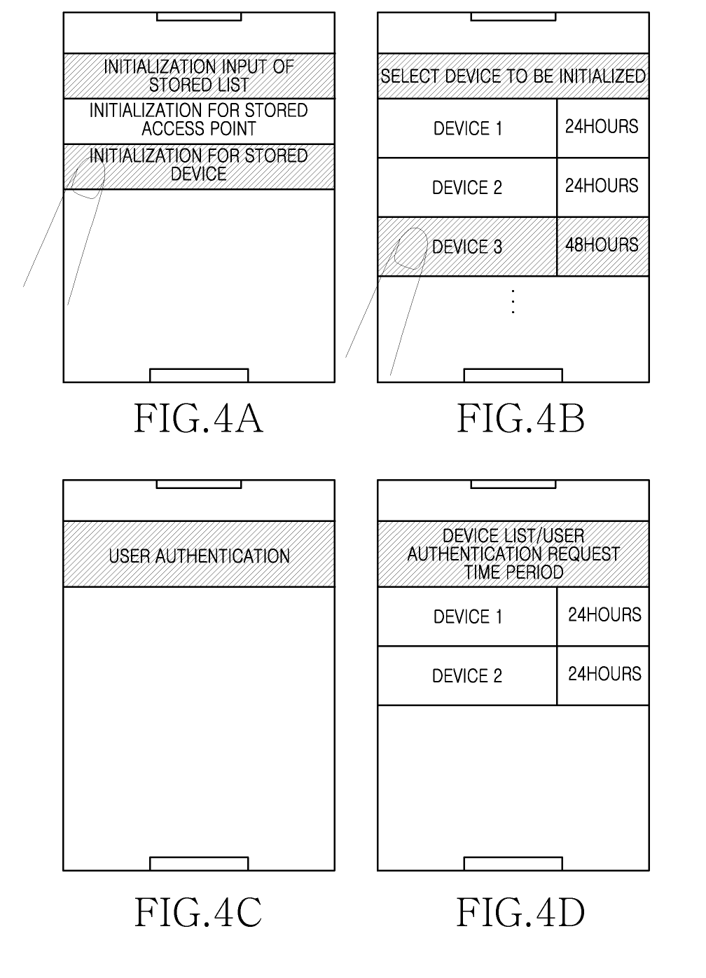

FIGS. 4A to 4D are diagrams illustrating initializing a stored access point list and a stored device list according to an embodiment of the present invention. FIG. 4A is a diagram illustrating receiving initialization of a stored list according to an embodiment of the present invention. Initially, when a user wants to transfer ownership of the electronic device to a stranger, the user may input initialization for a stored list so as to prohibit a stored access point list or a stored device list from being disclosed to the stranger. For example, when the user wants to sell the electronic device, which has been used by the user, to a stranger, access points to which the user has connected frequently are stored in the electronic device, which may cause invasion of the user's privacy. Therefore, the user deletes the access point list and the device list which are stored in the electronic device before transferring ownership of the electronic device to the stranger, so that it is possible to prevent the user's privacy from being invaded.

In addition, even in a case where the user does not transfer ownership of the electronic device to a stranger, the stored access point list and the stored device list may still be deleted. For example, when the user moves to another office or moves out of the user's home, the access points covering areas including the original office or home do not need to be stored in the electronic device anymore. This is due to the fact that if the previous access points are not deleted and are still stored in the electronic device, the electronic device requests user authentication at the previously set predetermined time periods, which may be inconvenient to the user at the new office and/or home.

In this case, the initialization of a stored list may be defined as the initialization of at least one access point or device of a stored access point list or device list. Specifically, the initialization of a stored list may be defined as a deletion of at least one access point stored in the access point list and a new synchronization of stored access points, or as a deletion of at least one device stored in the device list and a new synchronization of stored devices. In other words, if the electronic device receives initialization of an initially stored list, the electronic device displays respective lists to be initialized such that the user selects at least one of initialization of stored access points and initialization of stored devices. In the present embodiment, the electronic device receives the initialization of devices contained in stored lists.

FIG. 4B is a diagram illustrating receiving devices to be initialized according to an embodiment of the present invention. As illustrated in FIG. 4B, the electronic device displays stored devices and their respective user authentication request time periods together such that a device to be initialized is selected in a stored device list. For example, the electronic device displays the user authentication request time period of 24 hours set for a device 1, the user authentication request time period of 24 hours set for a device 2, and the user authentication request time period of 48 hours set for a device 3, on a touchscreen. Therefore, the user can check respective devices and their user authentication request time periods displayed on the touchscreen and select a device to be initialized. In the present embodiment, the device 3, the user authentication request time period of which is set to 48 hours, is selected as a device to be initialized. Although not illustrated in FIG. 4B, the user can select all of the devices 1, 2, and 3 as devices to be initialized.

FIG. 4C is a diagram illustrating connecting to a server and undergoing user authentication according to an embodiment of the present invention. In the present embodiment, user authentication may be defined as undergoing an arbitrary authentication method by a server in order to initialize an access point list and device list stored in the electronic device. Specifically, when the electronic device receives initialization of a stored list, the electronic device connects to the server, receives user authentication from a user, and receives a result of the user authentication from the server. For example, when the electronic device connects to the server, the server may request user authentication from the electronic device using an automatic response service or the like. That is, the electronic device receives a predetermined user authentication, such as the resident registration number of the user, from the user, transmits the same to the server, and receives a result of the user authentication from the server.

FIG. 4D is a diagram illustrating a device list and user authentication request time periods stored after a selected device has been initialized according to an embodiment of the present invention. As illustrated in FIG. 4D, the electronic device displays a list of stored devices, which remain after a selected device has been initialized, and their respective user authentication request time periods together. Specifically, the user can check that the initially stored device 3 has been deleted by initialization, and that the currently stored devices are the device 1 and the device 2 along with their respective authentication request time periods of 24 hours. That is, when the electronic device has determined that it has not connected to the device 1 within 24 hours, the electronic device immediately requests user authentication. Similarly, when the electronic device has determined that the electronic device has not connected to the device 2 within 24 hours, the electronic device immediately requests user authentication to check whether a user currently possessing the electronic device is the legal owner.

Although not illustrated in FIG. 4D, the electronic device according to the present invention automatically stores an access point list and a device list in an area to which factory reset cannot be applied. This is to prohibit personal privacy from being invaded, and prevents a stranger from freely observing the stored list to improve security even when the electronic device is stolen or lost.

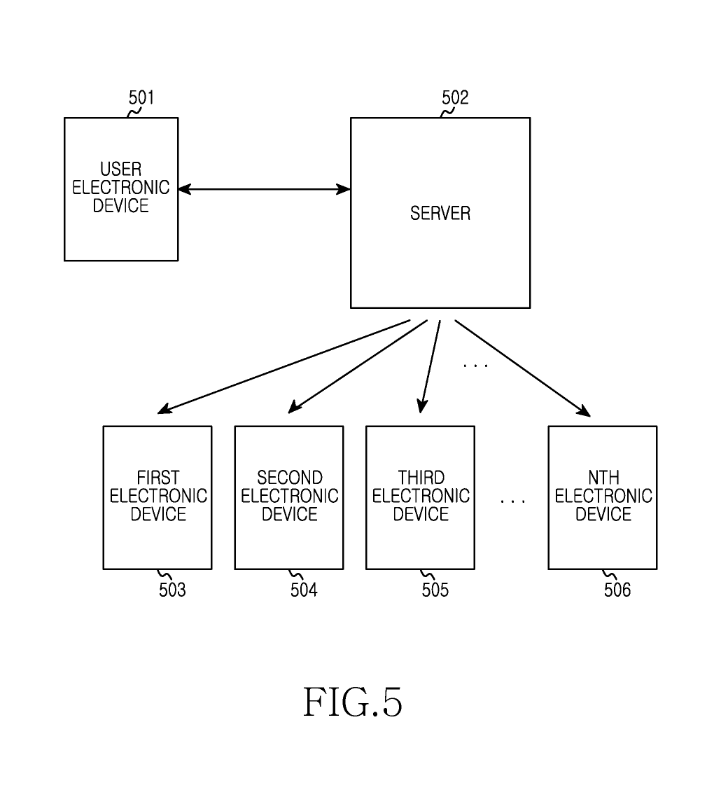

FIG. 5 is a diagram illustrating an embodiment for transmitting an emergency message to at least one email address and telephone number stored in a server when user authentication fails. As illustrated in FIG. 5, when a server transmits an emergency message to at least one email address and telephone number stored in the server, this corresponds to a case in which user authentication has failed. The following description includes examples in which user authentication has failed.

In a first case, an electronic device determines that it has not connected to at least one of a stored access point and device, so that user authentication is requested. However, the user authentication fails. Specifically, when determining that the electronic device has not connected to at least one automatically stored access point and device within a predetermined time period, the electronic device requests user authentication in order to determine whether the user currently possessing the electronic device is the legal user. Thereafter, the electronic device receives user authentication from the user through a predetermined authentication method, such as a password, pattern matching, face recognition, fingerprint scan, or the like. If, upon reception of a result of the user authentication from the server, the electronic device determines that the user authentication has failed, the electronic device maintains a locked state, and requests a server to transmit an emergency message to a set email address and telephone number.

In a second case, the electronic device receives initialization of a stored list, so that the electronic device requests user authentication, but, as a result of the user authentication, the user authentication fails. Specifically, when receiving an input for initialization of at least one of a stored access point list and a stored device list, the electronic device requests user authentication from a server in order to determine whether the user currently possessing the electronic device is the legal user. Thereafter, the electronic device connects to the server, receives user authentication from the user, and receives a result of the user authentication from the server. For example, when the electronic device connects to the server, the server may request user authentication from the electronic device using an automatic response service or the like. That is, the electronic device receives a predetermined user authentication, such as the resident registration number of the user, from the user, transmits the same to the server, and receives a result of the user authentication from the server. If, upon reception of the result of the user authentication from the server, the electronic device determines that the user authentication has failed, the electronic device maintains a locked state, and requests the server to transmit an emergency message to a set email address and telephone number.

In order for the electronic device to request the server to transmit the emergency message to the set email address and telephone number, the electronic device needs to register the email address and telephone number with the server in advance. In this case, the email address and telephone number registered in the server may be the email address and telephone number of an acquaintance close to the user, such as a family member, friend or colleague of the user using the electronic device. Transmission of the emergency message by the server is a result of the fact that user authentication has failed in the electronic device, so that the user currently possessing the electronic device is not the legal user. The relationship among the electronic device of the user, the server and a registered electronic device is described below in further detail.

Similar to the above-described two cases, if an electronic device 501 determines that user authentication has failed, the electronic device 501 requests a server 502 to transmit an emergency message to a set email address and telephone number. Specifically, the electronic device 501 may make a request including at least one piece of current location information, the SSID and BSSID information of a connected access point, the ID information, and cell-related information of a connected base station, USIM information and user application log information, and transmit the same to the server 502.

In this case, the SSID of the access point is the name of the access point, and may be included in a beacon message which is periodically broadcast by a corresponding access point. In addition, the BSSID of the access point is the unique information of the access point, and may be included in all packets transmitted by the corresponding access point. In addition, the ID information of the base station is the unique identity information of the base station to which the electronic device connects, and may be included in a beacon message which is periodically broadcast by the corresponding base station. In addition, the cell-related information of the base station is the unique identity information of a cell managed by a base station to which the electronic device connects, and may be included in a beacon message which is periodically broadcast by the corresponding base station. In addition, the USIM information of the electronic device is unique information for identifying the user of an electronic device, and may be defined as a value stored in a USIM card mounted in the electronic device. In addition, the user application log information may be defined as a list of applications executed by a user.

The electronic device 501 sends a request, including the above-described information, to the server 502 to transmit the emergency message to the set email address and telephone number. Therefore, the server 502 may transmit the emergency message including the location information of the electronic device or the like to the set email address and telephone number. In FIG. 5, an embodiment in which the server 502, from which transmission of the emergency message is requested by the electronic device 501, transmits the emergency message to predetermined electronic devices 503 to 506 is illustrated. Therefore, the respective users of the predetermined electronic devices 503 to 506 which receive the emergency message from the server 502 can take an action suitable for a situation.

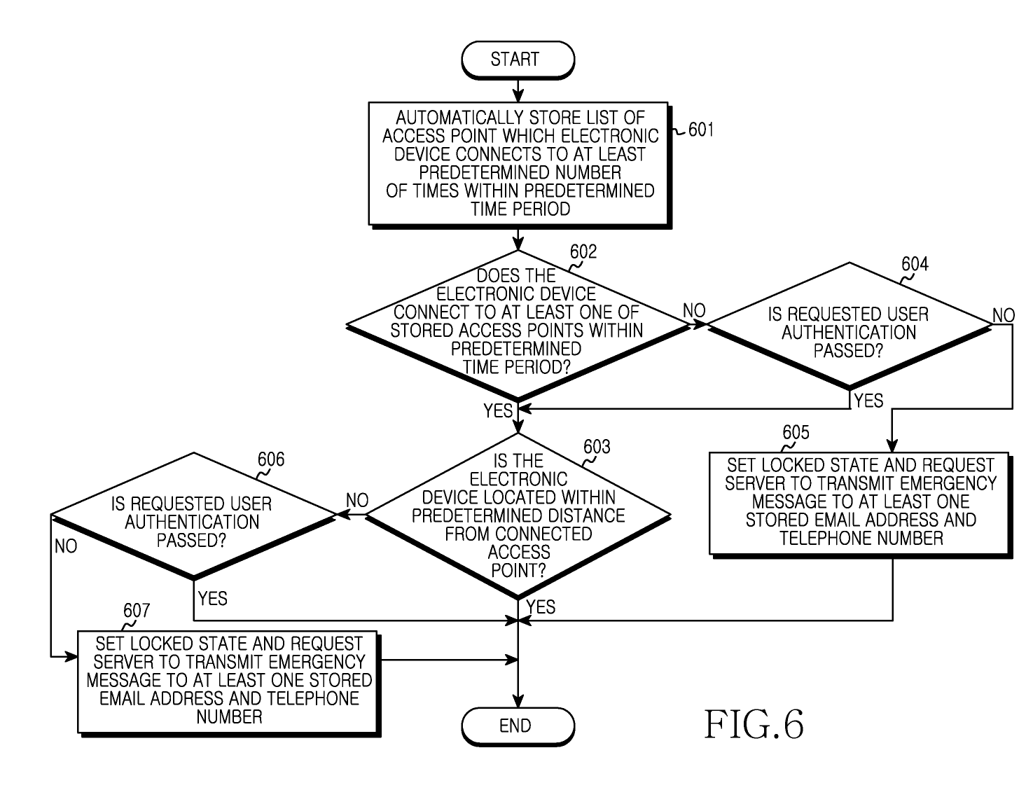

FIG. 6 is a diagram illustrating an operation flow of an electronic device for performing user authentication using access points according to an embodiment of the present invention. As illustrated in FIG. 6, in step 601, the electronic device may automatically store a list of at least one access point connected to the electronic device at least a predetermined number of times within a predetermined time period. Specifically, the electronic device searches for access points connected to the electronic device in real time in order to automatically store a list of at least one access point connected to the electronic device at least the predetermined number of times within the predetermined time period. For example, when a user transmits and receives a call in an area covered by an “access point 1” using the electronic device, the electronic device searches for access points connected to the electronic device in real time, and stores the “access point 1” in a list of connected access points along with a connection date, time and the like. In addition, when a user accesses the Internet using the electronic device in an area covered by an “access point 3,” the electronic device stores the access point 3 in a list of connected access points along with a connection date, time and the like. In another example, when a user transmits a text message in an area covered by an “access point 2” using the electronic device, the electronic device stores the access point 3 in the list of access points connected to the electronic device along with a connection date, time and the like. That is, as in the above-described example, the electronic device searches for access points connected to the electronic device in real time, and stores the detected access points in the list of connected access points in order to automatically store a list of at least one access point connected to the electronic device at least a predetermined number of times within a predetermined time period. In the above described example, it is assumed that the predetermined time period is 24 hours, and the predetermined number of times is 4 times. If the electronic device has connected to the “access point 1,” “access point 2,” and “access point 3” at least 4 times within 24 hours, the electronic device automatically stores these access points in an access point list. That is, the electronic device automatically stores an access point to which the electronic device has connected at least a predetermined number of times within a predetermined time period in the access point list.

In step 602, the electronic device determines whether it connects to at least one of the stored access points. The purpose of this step is to request user authentication set by the electronic device itself. In contrast to the conventional electronic devices, the electronic device according to the present invention autonomously requests user authentication from a user at a predetermined time period even though the user does not manually request the user authentication, thereby improving the security of the electronic device.

If the electronic device determines that it has not connected to at least one of the stored access points within the predetermined time period, the electronic device determines whether it is located within a predetermined distance from the connected access point in step 603. The electronic device according to the present invention also stores the GPS location value of a corresponding access point when storing the access point list. In this case, the electronic device stores the GPS location values with respect to access points so that it requests user authentication when it cannot check that it is located within the predetermined distance from a connected access point, although the electronic device connects to at least one stored access point within a predetermined time period. Specifically, the reason for this is that, when the electronic device is stolen and hacked by a stranger, the stranger discovers stored access points, and freely uses the electronic device. Accordingly, the electronic device stores a connected access point and a corresponding GPS location value to determine whether the electronic device is substantially located within the service area of the stored access point. That is, although the electronic device connects to the stored access point within the predetermined time period, whether the electronic device is located within a predetermined distance from the access point to which the electronic device connects is checked using the Equation (1) above.

If the electronic device determines in step 602 that it has not connected to at least one of the stored access points within a predetermined time period, the electronic device determines whether the requested user authentication has passed in step 604. In this case, the user authentication may be defined as an arbitrary authentication method for unlocking a locked state set for the security of the electronic device. For example, the predetermined authentication method may include a password to be input to the electronic device, pattern matching, face recognition, fingerprint scan, or the like. That is, the user, from which the predetermined user authentication is requested by the electronic device, can continuously use the electronic device only when the user unlocks the electronic device. For example, if the electronic device is set to be locked using a password, the user must input a predetermined password to the electronic device to unlock the electronic device in order to use the electronic device continuously. Therefore, according to the present invention, the electronic device undergoes double user authentication, thereby improving the security of the electronic device.

If the electronic device has determined that the requested user authentication has passed, the electronic device repeatedly performs the above-described determination step 603. On the other hand, if the electronic device has determined that the requested user authentication has failed, the electronic device sets a locked state, and requests the server to transmit an emergency message to at least one stored email address and telephone number in step 605. Specifically, when determining that the electronic device has not connected to at least one automatically stored access point within the predetermined time period, the electronic device requests user authentication in order to determine whether the user currently possessing the electronic device is the legal user. Thereafter, the electronic device receives user authentication from the user using a predetermined authentication method, such as a password, pattern matching, face recognition, fingerprint scan, or the like. If, upon reception of a result of the user authentication from the server, the electronic device determines that the user authentication has failed, the electronic device maintains a locked state, requests the server to transmit an emergency message to a set email address and telephone number, and finally ends the operation flow of the electronic device.

If the electronic device determines that it is located within the predetermined distance from the connected access point in the above-described determination step 603, the electronic device ends the operation flow without requesting user authentication. However, if the electronic device determines that it is not located within the predetermined distance from the connected access point, the electronic device determines whether the requested user authentication has passed in step 606. This determination step is identical to the above-described determination step 604.

If the electronic device has determined that the requested user authentication has passed, it ends the operation flow. On the other hand, if the electronic device has determined that the requested user authentication has failed, the electronic device sets a locked state, and requests the server to transmit an emergency message to at least one stored email address and telephone number in step 607. This step is identical to the above-described step 605.

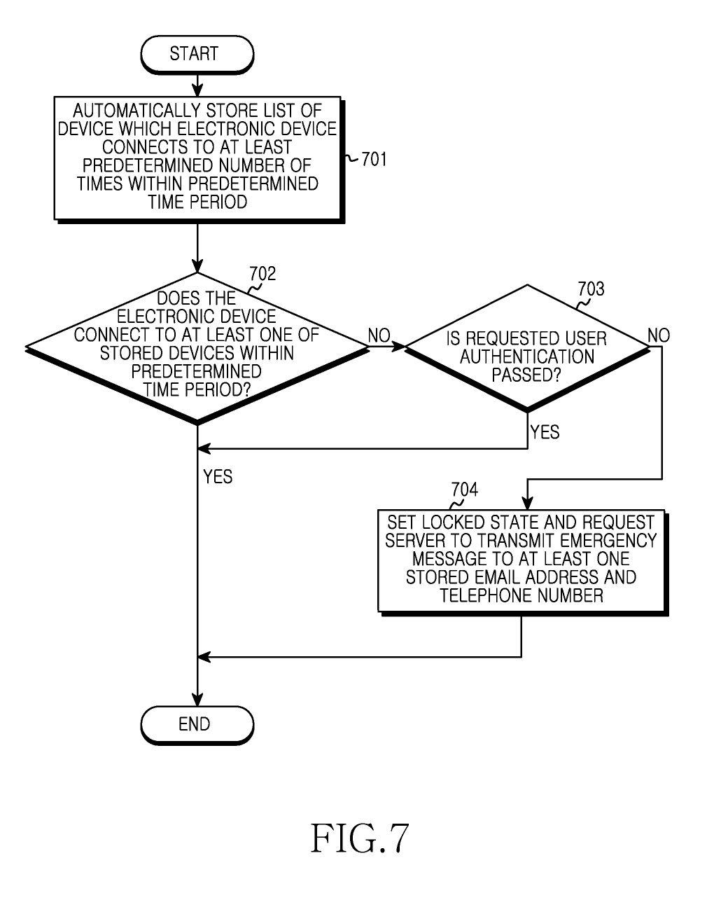

FIG. 7 is a diagram illustrating an operation flow of an electronic device for performing user authentication using devices according to an embodiment of the present invention. As illustrated in FIG. 7, the electronic device automatically stores a list of devices connected to the electronic device at least a predetermined number of times within a predetermined time period in step 701. In this case, the devices may include peripheral devices capable of wirelessly communicating with the electronic device. Specifically, the device may include a wireless headset capable of performing Near Field Communication (e.g., Bluetooth or the like), a personal computer, a vehicle or broadcasting receiver, and the like. For example, a user may listen to music stored in the electronic device by using a wireless headset set to perform Near Field Communication with the electronic device, work on a personal computer (PC) by transmitting a file stored in the electronic device to the PC, and watch moving images on the screen of a broadcasting receiver by transmitting the moving images stored in the electronic device to the broadcasting receiver. That is, the electronic device automatically stores a list of at least one device to which the electronic device has connected not less than a predetermined number of times within a predetermined time period.

Thereafter, the electronic device determines whether it connects to at least one of the stored devices within the predetermined time period step 702. The purpose of this step is to request user authentication set by the electronic device itself. That is, the electronic device according to the present invention autonomously requests user authentication from the user at a predetermined time period even though the user does not manually request the user authentication, thereby improving the security of the electronic device.

If the electronic device determines that it has connected to at least one of the stored devices within the predetermined time period, the electronic device ends the operation flow. On the other hand, if the electronic device determines that it has not connected to at least one of the stored devices within the predetermined time period, the electronic device determines whether the requested user authentication has passed in step 703. In this case, the user authentication may be defined as an arbitrary authentication method for unlocking a locked state set for the security of the electronic device. For example, the predetermined authentication method may include a password to be input to the electronic device, pattern matching, face recognition, fingerprint scan, or the like. That is, the user, from which the predetermined user authentication is requested by the electronic device, can continuously use the electronic device only when the user unlocks the electronic device by using the predetermined authentication method. For example, if the electronic device is set to be locked using a password, the user must input a predetermined password to the electronic device to unlock the electronic device in order to use the electronic device continuously. Therefore, according to the present invention, the electronic device undergoes double user authentication, thereby improving the security of the electronic device.

If the electronic device has determined that the requested user authentication has passed, the operation flow of the electronic device is ended. On the other hand, if the electronic device has determined that the requested user authentication has failed, the electronic device sets a locked state, and requests the server to transmit an emergency message to at least one stored email address and telephone number in step 704. Specifically, when determining that the electronic device has not connected to at least one automatically stored device within the predetermined time period, the electronic device requests user authentication in order to determine whether the user currently possessing the electronic device is the legal user. Thereafter, the electronic device receives user authentication from the user through a predetermined authentication method, such as a password, pattern matching, face recognition, fingerprint scan, or the like. If, upon reception of a result of the user authentication from the server, the electronic device determines that the user authentication has failed, the electronic device maintains a locked state, requests the server to transmit an emergency message to a set email address and telephone number, and finally ends the operation flow of the electronic device.

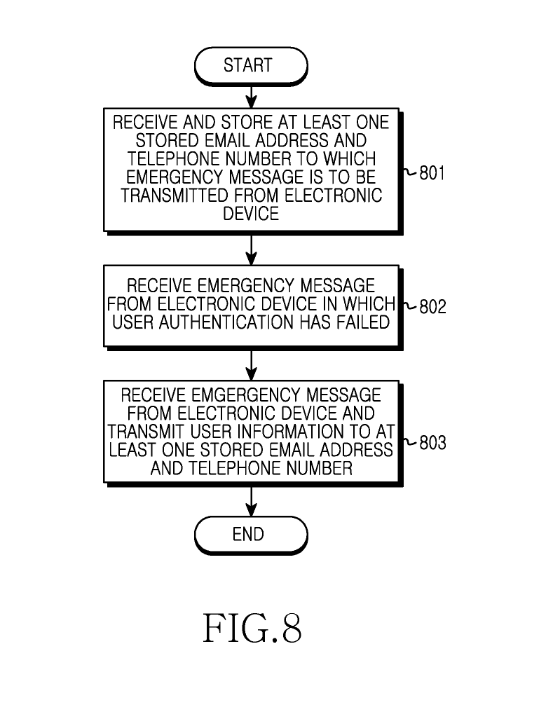

FIG. 8 is a diagram illustrating an operation flow of a server for transmitting an emergency message to a stored email address and telephone number according to an embodiment of the present invention. As illustrated in FIG. 8, a server receives at least one email address and telephone number, to which an emergency message will be transmitted, from an electronic device and stores the same in step 801. That is, in order for the server to transmit the emergency message to the set email address and telephone number, the server receives and stores a certain email address and telephone number from the electronic device in advance. For example, the email address and telephone number registered in the server may be the email address and telephone number of an acquaintance close to the user, such as a family member, friend or colleague of the user possessing the electronic device. Transmission of the emergency message by the server is a result of a scenario in which the user authentication has failed i, so that the user currently possessing the electronic device is not the legal user.

The server, which has received and stored at least one email address and telephone number for transmission of the emergency message, receives an emergency message from an electronic device in which the user authentication has failed in step 802. Specifically, the server may receive the emergency message including at least one piece of the current location information of the electronic device, the SSID and BSSID information of a connected access point, the ID and cell-related information of a connected base station, USIM information, and user application log information, from the electronic device.

Thereafter, the server receives the emergency message from the electronic device and transmits user information to the at least one stored email address and telephone number in step 803. That is, the server may transmit the emergency message including the location information of the electronic device or the like to the stored email address and telephone number. Therefore, the respective users of the predetermined electronic devices which receive the emergency message from the server can take an action suitable for a situation.

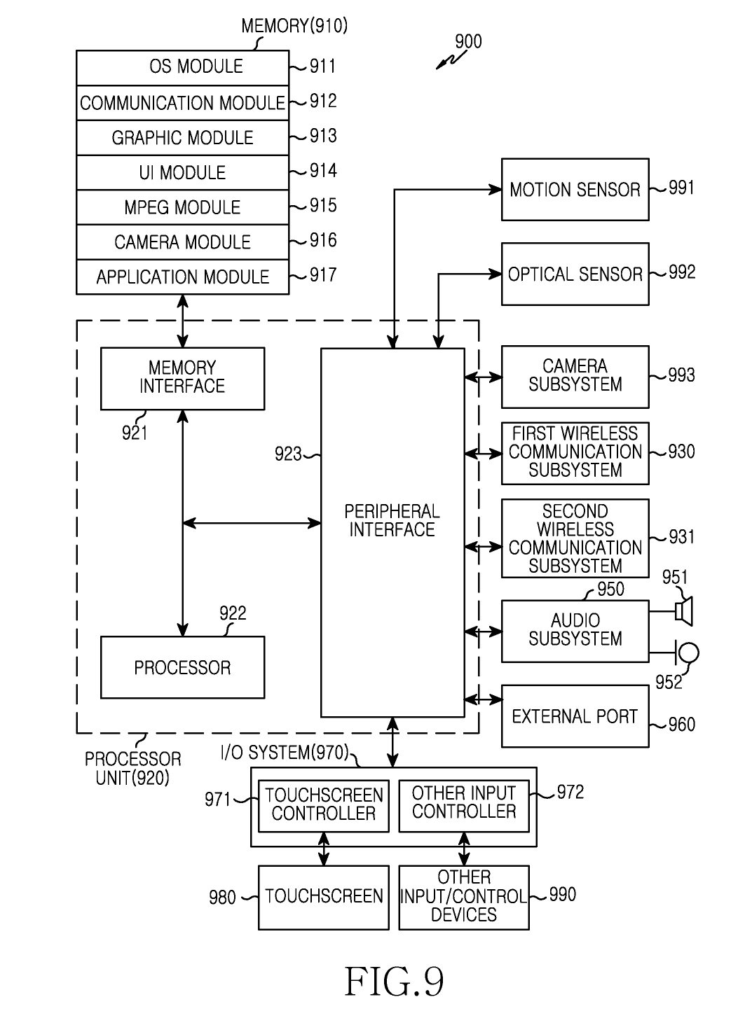

FIG. 9 is a block diagram illustrating a configuration of an electronic device according to an embodiment of the present invention. Such an electronic device 900 may be a portable electronic device, and examples thereof may include a portable terminal, a mobile phone, a mobile pad, a media player, a tablet computer, a handheld computer, or a Personal Digital Assistant (PDA), and the like. In addition, the electronic device may be a portable electronic device having two or more functions corresponding to the above-described devices.

The electronic device 900 includes a memory 910, a processor unit 920, a first wireless communication subsystem 930, a second wireless communication subsystem 931, an external port 960, an audio subsystem 950, a speaker 951, a microphone 952, an input/output (I/O) system 970, a touchscreen 980, and other input/control devices 990. The electronic device 900 may include one or more of the memory 910 and the external port 960.

The processor unit 920 may include a memory interface 921, at least one processor 922, and a peripheral interface 923. In some cases, the processor unit 920 will also be referred to as a processor. According to the present invention, the processor unit 920 determines whether the electronic device has connected to at least one of the stored access point and device within a predetermined time period. The purpose of this determination is to request user authentication set by the electronic device itself. In contrast to the conventional electronic device described above, the electronic device 900 (via the processor unit 920) according to the present invention autonomously requests user authentication from the user at a predetermined time period even though the user does not manually request the user authentication, thereby improving improved security of the electronic device.

In addition, the processor unit 920 checks that the electronic device has connected to at least one stored access point within a predetermined time period and determines whether the electronic device is located within a predetermined distance from the connected access point. In addition, the processor unit 920 may check whether the electronic device is located within the predetermined distance from the connected access point, receive a predetermined user authentication to determine whether the user authentication has passed, and, when it is determined that the user authentication has failed, sets a locked state. In this case, the user authentication may be defined as an arbitrary authentication method for unlocking a lock state set for the security of the electronic device. For example, the predetermined authentication method may include a password to be input to the electronic device, pattern matching, face recognition, fingerprint scan, or the like. That is, the user, from which the predetermined user authentication is requested by the electronic device, can continuously use the electronic device only when the user unlocks the electronic device by using the predetermined authentication method. For example, if the electronic device is set to be locked using a password, the user must input a predetermined password to the electronic device to unlock the electronic device in order to use the electronic device continuously. Therefore, according to the present invention, the electronic device undergoes double user authentication, thereby improving the security of the electronic device.

In addition, the processor unit 920 determines whether user authentication has passed, and, when the user authentication has passed, initializes at least one of the stored access point list and device list. Specifically, when the user wants to transfer ownership of the electronic device to a stranger, the user may input the initialization of a stored list so as to prohibit a stored access point list and a stored device list from being disclosed to the stranger. For example, when the user wants to sell the electronic device, which has been used by the user, to a stranger, access points to which the user has frequently connected are stored in the electronic device, which may cause the invasion of the user's privacy. Therefore, the user deletes the access point list and the device list which are stored in the electronic device before transferring ownership of the electronic device to a stranger, so that it is possible to prevent the user's privacy from being invaded.

The processor 922 executes various software programs to perform various functions for the electronic device 900, and performs processes and controls for voice communication and data communication. In addition to these general functions, the processor 922 executes a specific software module (instruction set) stored in the memory 910 and performs various specific functions corresponding to the software module. That is, the processor 922 performs methods of the embodiments of the present invention in cooperation with software modules stored in the memory 910.

The processor 922 may include at least one data processor, image processor, or codec. The data processor, the image processor, or the codec may be configured separately. Also, the processor 922 may be configured by a plurality of processors performing different functions. The peripheral interface 923 connects various peripheral devices and the I/O system 970 of the electronic device 900 to the processor 922 and the memory 910 (through the memory interface 921).

The various elements of the electronic device 900 may be coupled by at least one communication bus (not illustrated) or stream line (not illustrated).

The external port 960 is used for connection to other electronic devices directly or indirectly through a network (for example, Internet, intranet, or wireless LAN). The external port 960 may be, for example, a universal serial bus (USB) port or a FireWire port, but is not limited thereto.

A motion sensor 991 and a first optical sensor 992 may be connected to the peripheral interface 923 to facilitate various functions. For example, the motion sensor 991 and the optical sensor 992 may be connected to the peripheral interface 923 to detect a motion of the electronic device 900 and detect light from the outside. In addition, other sensors such as a positioning system, a temperature sensor, and a biosensor (not shown) may be connected to the peripheral interface 923 to perform relevant functions.

A camera subsystem 993 may perform camera functions such as photographing and video clip recording.

The optical sensor 992 may include a CCD (charged coupled device) or a CMOS (complementary metal-oxide semiconductor) device.

A communication function is performed through one or more wireless communication subsystems 930 and 931. The communication systems 930 and 931 may include a radio frequency (RF) receiver and transceiver and/or an optical (e.g., infrared) receiver and transceiver. The first wireless communication subsystem 930 and the second wireless communication subsystem 931 may be divided according to communication networks through which the electronic device 900 communicates. For example, the communication networks may include, but are not limited to, communication subsystems operated through a GSM (Global System for Mobile Communication) network, an EDGE (Enhanced Data GSM Environment) network, a CDMA (Code Division Multiple Access) network, a W-CDMA (W-Code Division Multiple Access) network, an LTE (Long Term Evolution) network, an OFDMA (Orthogonal Frequency Division Multiple Access) network, a WiFi (Wireless Fidelity) network, a WiMax network, and/or a Bluetooth network.

The audio subsystem 950 is connected to the speaker 951 and the microphone 952 to perform audio stream input/output functions such as voice recognition, voice replication, digital recording, and phone functions. That is, the audio subsystem 950 communicates with the user through the speaker 951 and the microphone 952. The audio subsystem 950 receives a data stream through the peripheral interface 923 of the processor unit 920 and converts the received data stream into an electric stream. The electric stream is transmitted to the speaker 951. The speaker 951 converts the electric stream into sound waves audible by humans and outputs the same. The microphone 952 converts sound waves received from humans or other sound sources into an electric stream. The audio subsystem 950 receives an electric stream converted from the microphone 952. The audio subsystem 950 converts the received electric stream into an audio data stream and transmits the audio data stream to the peripheral interface 923. The audio subsystem 950 may include, for example, an attachable/detachable earphone, a headphone, or a headset.

The I/O subsystem 970 may include a touchscreen controller 971 and/or an other input controller 972. The touchscreen controller 971 may be connected to the touchscreen 980. The touchscreen 980 and the touchscreen controller 971 may detect a touch, a motion, or a stop thereof by using multi-touch detection technologies including a proximity sensor array or other elements, as well as capacitive, resistive, infrared and surface acoustic wave technologies for determining one or more touch points with the touchscreen 980. The other input controller 972 may be connected to the other input/control devices 990. The other input/control devices 990 may include one or more buttons, a rocker switch, a thumb wheel, a dial, a stick, and/or a pointer device such as a stylus.

The touchscreen 980 provides an I/O interface between the electronic device 900 and the user. That is, the touchscreen 980 transmits a user touch input to the electronic device 900. Also, the touchscreen 980 is a medium that displays an output from the electronic device 900 to the user. That is, the touchscreen 980 displays a visual output to the user. The visual output may be represented by a text, a graphic, a video, or a combination thereof.

The touchscreen 980 may use various display technologies. For example, the touchscreen 980 may use an LCD (liquid crystal display), an LED (Light Emitting Diode), an LPD (light emitting polymer display), an OLED (Organic Light Emitting Diode), an AMOLED (Active Matrix Organic Light Emitting Diode), or an FLED (Flexible LED). In the present invention, when determining that the electronic device has connected to at least one of a stored access point and device within a predetermined time period, the touchscreen 980 requests a predetermined user authentication, receives initialization of the at least one list of the stored access point list and device list, and connects to a server to request the user authentication.

The memory 910 may be connected to the memory interface 921. The memory 910 may include one or more high-speed random-access memories (RAMs) such as magnetic disk storage devices, one more nonvolatile memories, one or more optical storage devices, and/or one or more flash memories (for example, NAND flash memories or NOR flash memories).

The memory 910 may also store software. Elements of the software include an operation system (OS) module 911, a communication module 912, a graphics module 913, a user interface (UI) module 914, a MPEG module 915, a camera module 916, and one or more application modules 917. Also, since the module that is an element of the software may be represented as a set of instructions, the module may be referred to as an instruction set. The module may also be referred to as a program. According to the present invention, the memory 910 automatically stores a list of at least one access point or a list of at least one device to which the electronic device has connected at least a predetermined number of times within the predetermined time period, and also the GPS location values of the access points along with the stored list of access points. In addition, the memory 910 stores the list of access points and the list of devices in an area to which factory reset cannot be applied, and stores the GPS location values of the access points in an area to which factory reset cannot be applied.

The OS module 911 (for example, WINDOWS, LINUX, Darwin, RTXC, UNIX, OS X, or an embedded OS such as VxWorks) includes various software elements for controlling general system operations. For example, general system operation controls include memory control/management, storage hardware (device) control/management, and power control/management. The OS module also performs a function for enabling smooth communication between various hardware elements (devices) and software elements (modules).

The communication module 912 may enable communication with other electronic devices (such as computers, servers, and/or portable terminals) through the wireless communication subsystems 930 and 931 or the external port 960. In the present invention, the communication module 912 requests a server to transmit an emergency message to at least one stored email address and telephone number, and includes at least one of the current location information of the electronic device, the SSID and BSSID information of a connected access point, the ID and cell-related information of a connected base station, USIM information and user application log information, in a request. In addition, the communication module 912 receives a result of the user authentication from the server, and requests the server to transmit the emergency message to the at least one stored email address and telephone number.

The graphics module 913 includes various software elements for providing and displaying graphics on the touchscreen 980. The graphics may include, for example, texts, web pages, icons, digital images, videos, and animations. In the present invention, the touchscreen 980 displays a message about whether a smart rotation function is set, and receives a selection of a region included in the message.

The UI module 914 includes various software elements related to a user interface. Through the user interface module, the electronic device 900 provides information about how the state of a user interface changes and/or information about under what condition the state of a user interface changes.

The codec module 915 may include software elements related to video file encoding/decoding. The codec module 915 may include a video stream module such as an MPEG module or an H204 module. Also, the codec module 915 may include various audio file codec modules such as AAA, AMR, and WMA. Also, the codec module 915 includes an instruction set corresponding to the implementation methods of the present invention.

The camera module 916 may include camera-related software elements that enable camera-related processes and functions.

The application module 917 includes, for example, a browser application, an e-mail application, an instant message application, a word processing application, a keyboard emulation application, an address book application, a touch list application, a widget application, a digital right management (DRM) application, a voice recognition application, a voice replication application, a position determining function application, a location-based service (LBS) application, and the like.

In addition, various functions of the electronic device 900 according to the present invention, which have been described above and will be described below, may be implemented by any combination of hardware and/or software including one or more stream processings and/or an application-specific integrated circuit (ASIC).

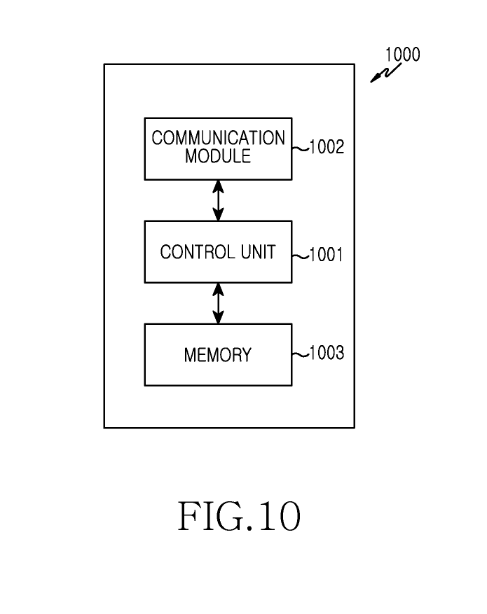

FIG. 10 is a block diagram illustrating a configuration of a server 1000 according to an embodiment of the present invention. As illustrated in FIG. 10, the server 1000 according to the present invention may include a control unit 1001, a communication module 1002 and a memory 1003.

The control unit 1001 controls an overall operation of the server. Specifically, the control unit 1001 is connected to the communication module 1002 and the memory 1003 to control the overall operation of the server.

The communication module 1022 receives the emergency message from the electronic device 900 in which user authentication has failed, and transmits user information to the at least one stored email address and telephone number. That is, the server may transmit the emergency message including the location information of the electronic device, or the like to the set email address and telephone number. Therefore, the respective users of the predetermined electronic devices which receive the emergency message from the server can take an action suitable for a situation. In addition, the communication module 1002 receives a request for user authentication from the electronic device 900, attempts to obtain the user authentication with the electronic device 900, and transmits a result of the user authentication to the electronic device 900.

The memory 1003 receives and stores at least one email address and telephone number to which an emergency message will be transmitted, from the electronic device 900.

The above configurations should be considered in descriptive sense only and not for the purpose of limitation. Those skilled in the art will understand that various changes may be made therein without departing from the scope of the present invention. For example, although the communication module 1002 and the memory 1003 are provided and illustrated separately, the control unit 1001 may be configured to perform all or some of the functions of the communication module 1002 and the memory 1003.

According to an electronic device and method for performing user authentication using access points and peripheral devices, when an electronic device does not connect to a stored access point or peripheral device within a predetermined time period, a predetermined user authentication is automatically requested, thereby improving security.

While the invention has been shown and described with reference to certain embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method for operating an electronic device, comprising:
determining whether the electronic device connects to at least one of a stored access point and a stored device within a predetermined time period; and
requesting a predetermined user authentication when it is determined that the electronic device has not connected to the at least one of the stored access point and device within the predetermined time period.

2. The method of claim 1, further comprising:
automatically storing a list of at least one access point or a list of at least one device to which the electronic device has connected at least a predetermined number of times within the predetermined time period.

3. The method of claim 2, further comprising:
automatically storing the list of at least one access point to which the electronic device has been connected at least the predetermined number of times with the predetermined time period comprises:
storing a GPS (Global Positioning System) location value of the access point along with the stored access point list.

4. The method of claim 2, wherein the access point list and the device list are stored in an area to which a factory reset cannot be applied.

5. The method of claim 3, wherein the GPS location value of the access point is stored in an area to which a factory reset cannot be applied.

6. The method of claim 1, wherein the device is at least one device capable of performing wireless communication.

7. The method of claim 1, wherein requesting the predetermined user authentication comprises:
checking that the electronic device has connected to the at least one stored access point within the predetermined time period;
determining whether the electronic device is located within a predetermined distance from the connected access point;
checking that the electronic device has not been located within the predetermined distance from the connected access point; and
requesting the predetermined user authentication.

8. The method of claim 7, wherein determining whether the electronic device is located within a predetermined distance from the connected access point comprises:
determining that the electronic device is located within the predetermined distance from the connected access point when the following Equation is satisfied:
2r≧\sqrt{(x₂−x₁)²+(y₂−y₁)²}
where r denotes the communication radius of the connected access point, (x₁, y₁) denotes a stored GPS coordinate of the connected access point, and (x₂, y₂) denotes a currently measured GPS coordinate of the connected access point.

9. The method of claim 1, further comprising:
receiving the predetermined user authentication and determining whether the user authentication has passed.

10. The method of claim 9, further comprising:
setting a locked state when it is determined that the user authentication has failed; and
requesting a server to transmit an emergency message to at least one stored email address and telephone number.

11. The method of claim 10, wherein requesting the server to transmit an emergency message to the at least one stored email address and telephone number comprises:
making a request including at least one piece of current location information, SSID (Service Set Identifier) information and BSSID (Basic Service Set Identifier) information of the connected access point, ID information and cell-related information of a connected base station, USIM information and user application log information.

12. The method of claim 1, further comprising:
registering at least one email address and telephone number, to which an emergency message will be transmitted, with a server.

13. The method of claim 1, further comprising:
receiving initialization for at least one list of the stored access point list and device list;
requesting user authentication from a server for initialization of the list;
connecting to the server to undergo the user authentication;
receiving a result of the user authentication from the server; and
determining whether the user authentication has passed.

14. The method of claim 13, further comprising:
initializing at least one list of the stored access point list and device list when it is determined that the user authentication has passed.

15. The method of claim 13, further comprising:
setting a locked state when it is determined that the user authentication has failed; and
requesting the server to transmit an emergency message to the at least one stored email address and telephone number.

16. The method of claim 15, wherein requesting the server to transmit an emergency message to the at least one stored email address and telephone number comprises:
making a request to include at least one piece of current location information of the electronic device, SSID (Service Set Identifier) information and BSSID (Basic Service Set Identifier) information of a connected access point, ID information and cell-related information of a connected base station, USIM information and user application log information.

17. A method for operating a server, comprising:
receiving an emergency message from an electronic device in which user authentication has failed; and
receiving the emergency message and transmitting user information to at least one stored email address and telephone number.

18. The method of claim 17, further comprising:
receiving and storing the at least one email address and telephone number, to which the emergency message will be transmitted, from the electronic device.

19. The method of claim 17, wherein the user information includes at least one piece of current location information of the electronic device, SSID (Service Set Identifier) information and BSSID (Basic Service Set Identifier) information of an access point connected to the electronic device, ID information and cell-related information of a base station connected to the electronic device, USIM information and user application log information of the electronic device.

20. The method of claim 17, further comprising:
receiving a request for user authentication from the electronic device;
performing the user authentication in cooperation with the electronic device; and
transmitting a result of the user authentication to the electronic device.

21. An electronic device, comprising:
a processor unit for determining whether an electronic device connects to at least one of a stored access point and a stored device within a predetermined time period; and
a touchscreen for requesting a predetermined user authentication when it is determined that the electronic device has not connected to the at least one of the stored access point and device within the predetermined time period.

22. The electronic device of claim 21, further comprising:
a memory for automatically storing a list of at least one access point or at least one device to which the electronic device has connected at least a predetermined number of times within the predetermined time period.

23. The electronic device of claim 22, wherein the memory stores a GPS location value of the access point along with the stored list of access point.

24. The electronic device of claim 22, wherein the memory stores the list of access point or the list of device in an area to which factory reset cannot be applied.

25. The electronic device of claim 23, wherein the memory stores the GPS location value of the access point in an area to which factory reset cannot be applied.

26. The electronic device of claim 21, wherein the device is at least one device capable of performing wireless communication.

27. The electronic device of claim 21, wherein the processor unit checks that the electronic device has connected to at least one stored access point within the predetermined time period, determines whether the electronic device is located within a predetermined distance from the connected access point, and checks that the electronic device has been located within the predetermined distance from the connected access point; and
wherein the touchscreen requests the predetermined user authentication.

28. The electronic device of claim 27, wherein the processor unit determines that the electronic device is located within the predetermined distance from the connected access point when the following Equation is satisfied:
2r≧\sqrt{(x₂−x₁)²+(y₂−y₁)²}
where r denotes a communication radius of the connected access point, (x₁, y₁) denotes a stored GPS coordinate of the connected access point, and (x₂, y₂) denotes a currently measured GPS coordinate of the connected access point.

29. The electronic device of claim 21, wherein the processor unit receives the predetermined user authentication and determines whether the user authentication has passed.

30. The electronic device of claim 29, wherein the processor unit sets a locked state when it is determined that the user authentication has failed; and the electronic device further comprises a memory for storing the at least one stored email address and telephone number, wherein the processor unit requests a server to transmit an emergency message to the at least one stored email address and telephone number.

31. The electronic device of claim 30, wherein the memory comprises a communication module for making a request which includes at least one piece of current location information of the electronic device, SSID (Service Set Identifier) information and BSSID (Basic Service Set Identifier) information of the connected access point, the ID information and cell-related information of a connected base station, USIM information, and user application log information.

32. The electronic device of claim 21, further comprising:
a memory for registering at least one email address and telephone number, to which an emergency message will be transmitted, with a server.

33. The electronic device of claim 21, wherein the touchscreen receives initialization of at least one list of a stored access point list and a stored device list, requests user authentication from a server, and connects to the server to undergo the user authentication;
wherein the processor unit determines whether the user authentication has passed; and
wherein the electronic device further comprises a memory for receiving a result of the user authentication from the server.

34. The electronic device of claim 33, wherein the processor unit initializes at least one list of the stored access point list and device list when it is determined that the user authentication has passed.

35. The electronic device of claim 33, wherein the processor unit sets a locked state when it is determined that the user authentication has failed; and
wherein the memory comprises a communication module for requesting the server to transmit an emergency message to the at least one stored email address and telephone number.

36. The electronic device of claim 35, wherein the communication module makes a request including at least one piece of current location information, SSID (Service Set Identifier) information and BSSID (Basic Service Set Identifier) information of a connected access point, ID information and cell-related information of a connected base station, USIM information, and user application log information.

37. A server comprising:
a communication module for receiving an emergency message from an electronic device in which user authentication has failed, and transmitting user information to at least one stored email address and telephone number; and
a processor unit for controlling an operation of the server.

38. The server of claim 37, further comprising:
a memory for receiving and storing at least one email address and telephone number, to which an emergency message will be transmitted, from the electronic device.

39. The server of claim 37, wherein the user information includes at least one piece of current location information of the electronic device, SSID (Service Set Identifier) information and BSSID (Basic Service Set Identifier) information of an access point connected to the electronic device, ID information and cell-related information of a base station connected to the electronic device, USIM information, and user application log information of the electronic device.

40. The server of claim 37, wherein the communication module receives a request for user authentication from the electronic device, performs the user authentication in cooperation with the electronic device, and transmits a result of the user authentication to the electronic device.
